(19) United States
(12) Patent Application Publication
(10) Pub. No.: US 2007/0210122 A1
(43) Pub. Date: Sep. 13, 2007

(54) Spray bottle

(76) Inventor: Thomas Arthur Giovannoni, Napa, CA (US)

Correspondence Address: Law Offices of Gerald L. Robertson & Assoc., 1110 Castle Oaks Drive, Napa, CA, 94558-1576, US

(21) Appl. No.: 11/373,427

(22) Filed: Mar. 8, 2006

(51) Int. Cl. B67D 5/60

(52) U.S. Cl. 222/464.4

(57) ABSTRACT

A spray bottle having a flexible weighted source tube such that product is continually drawn to a nozzle for dispersion notwithstanding the angle at which said bottle is positioned.

### STATEMENT OF GOVERNMENTAL ASSISTANCE

Applicant hereby represents that no part of the subject invention or application has come about with the assistance of government funds or by virtue of a government program.

### FIELD OF THE INVENTION

The present invention relates generally to spray bottles.

### BACKGROUND OF THE INVENTION

Many differing devices are developed yearly to improve and make more convenient the use of liquids such as cleaning agents, lubricants, moisteners, beauty aids such as perfumes, fragrant waters, and other substances which can be stored or held in a container and sprayed in a mist or aerosol form. Pressurized containers with their necessary gaseous agents, sometimes environmentally unfriendly, have in some measure lost ground to conventional spray bottles producing an “atomized” mist.

One of the challenges for consumers which is sometimes addressed by product manufacturers is the amount of liquid left inside the spray bottle when the source or feed tube cannot efficiently reach the last fraction of liquid. That fraction is essentially unavailable to the user which is especially frustrating when the remaining liquid is needed for the current purpose. Moreover, if the near empty bottle is discarded, product is wasted. For the value-conscious consumer, a primary alternative is to wait until a new bottle of product is obtained at which point the remaining fraction from the old bottle is added to the new (assuming it can be added) so that effectively none is wasted.

In the case where a spray bottle is low on product, the spray delivered from the nozzle may often times contain too much air resulting in a less than desired amount of product delivered out the nozzle. Some manufacturers have attempted to solve this problem by providing longer source or feed tubes to try to extract as much product as possible minimizing waste. Other manufacturers have even produced bottles with small pumps run by batteries with the object of using as much product as possible, thereby minimizing waste. The problems with such an approach are multiple; for example, the cost of the container, hence the product is higher to the consumer; additionally, batteries are introduced into the waste stream which is environmentally unfriendly. This trade off may or may not be balanced by the reduction of product which enters the municipal waste stream which is lessened by virtue of the battery driven pump.

What is needed then is a spray bottle designed to allow the maximum amount of product to be used without increasing cost or necessitating the use of components potentially harmful to the environment when discarded.

Another problem associated with the use of atomizing or spray bottles is the need to keep the bottle substantially upright when in use. Because of natural gravitational forces, liquid seeks to find its own level, and without pressurizing a spray or atomizing bottle, the same forces affect the performance of such devices. Therefor, if the user desires to hold the bottle in one position where the level of the bottle inhibits the ability of the feed or source tube to draw liquid uninhibited, then poor delivery of product results. This is particularly true when the volume of product in the bottle is at or below approximately 50%. At this point, the bottle must be kept substantially upright in order for the suction tube to continue to feed product to the spray nozzle. Once the suction tube draws a sufficient amount of air, the bottle then must be returned to the upright position and the trigger squeezed continually to draw a sufficient amount of product into the suction tube to feed the nozzle. Most consumers have experienced the frustration associated with this condition when trying to deliver product only to be annoyed by the constant interruption of product flow and having to re-position the spray bottle and continually squeeze the trigger to continue with the desired operation—a very inefficient way to apply product to the desired target or surface.

What is needed then is a spray bottle which is not inhibited by the gravitational forces which move the liquid level as the position of the spray bottle is changed.

### SUMMARY OF THE INVENTION

In the preferred embodiment, Applicant's invention employs a weight at the bottom of a flexible source or feed tube which keeps the tube in contact with sufficient product to keep delivery of the product continuous notwithstanding the position of the bottle. In another embodiment, a flexible sleeve or clamp and swivel are in communication with both the spray nozzle and the source tube to facilitate the movement of the source tube as it follows the product as a result of the weight responding to gravitational forces.

### BRIEF DESCRIPTION OF THE DRAWINGS

FIG. 1 is a frontal view of applicant's invention.

FIG. 2 is a frontal view of the spray nozzle, trigger, cap and source tube further disclosing one mode of source tube design.

FIG. 3 is an oblique view of a spray bottle having low liquid and positioned at an extreme angle, showing the following position of the improved source tube.

### DETAILED DESCRIPTION OF THE INVENTION

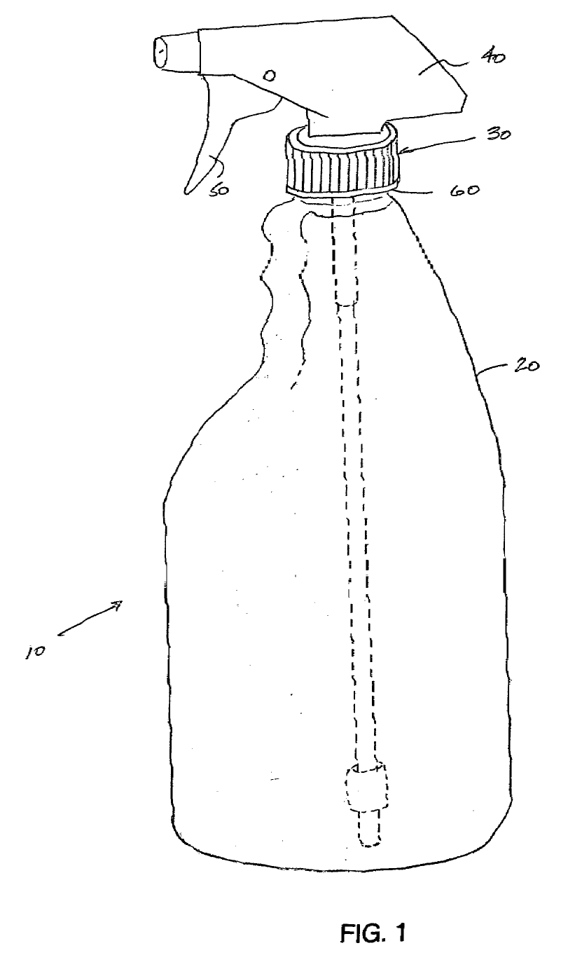

FIG. 1 depicts the improved spray bottle 10 developed by Applicant. As in most atomizing or spray-type bottles, a vessel 20 holds liquid or other product, and a delivery mechanism 30 is provided to source the product, direct it to a nozzle 40 which is typically actuated by a trigger 50. In the preferred embodiment, a threaded cap 60 secures delivery mechanism 30 to vessel 20, which has a mating threaded mouth to accept the cap. Extending down into vessel 20 is a suction tube 70, which, as trigger 50 is continually squeezed, allows product to be drawn up said tube 70 to be delivered from the tip of nozzle 40.

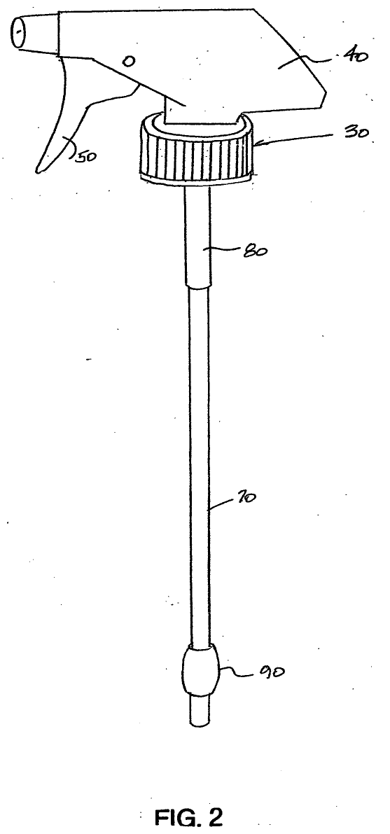

FIG. 2 shows the details of source tube 70. In this embodiment, a flexible sleeve 80 is provided proximate to the top of source tube 70 to allow tube 70 to move relative to the nozzle. A weight 90 is provided proximate to the bottom of tube 70 to allow gravitational force to change position of source tube 70 consistent with the changing level of product resulting from differing positions of the bottle. In this way, tube 70 “follows” the liquid to continue to feed a continual flow of product to nozzle 40, thereby virtually eliminating the feed problems commonly associated with using the spray bottle in other than the upright position as product volume reduces to approximately 50% and below.

Source tube 70 is connected to said nozzle via flexible sleeve 80. In another embodiment of the present invention, a clamp and swivel means may be employed instead of said sleeve. Any suitable type of junction which allows source tube 70 to bend, rotate or otherwise allow weight 90 to succumb to gravity and follow the product level is sufficient to function according to applicant's invention.

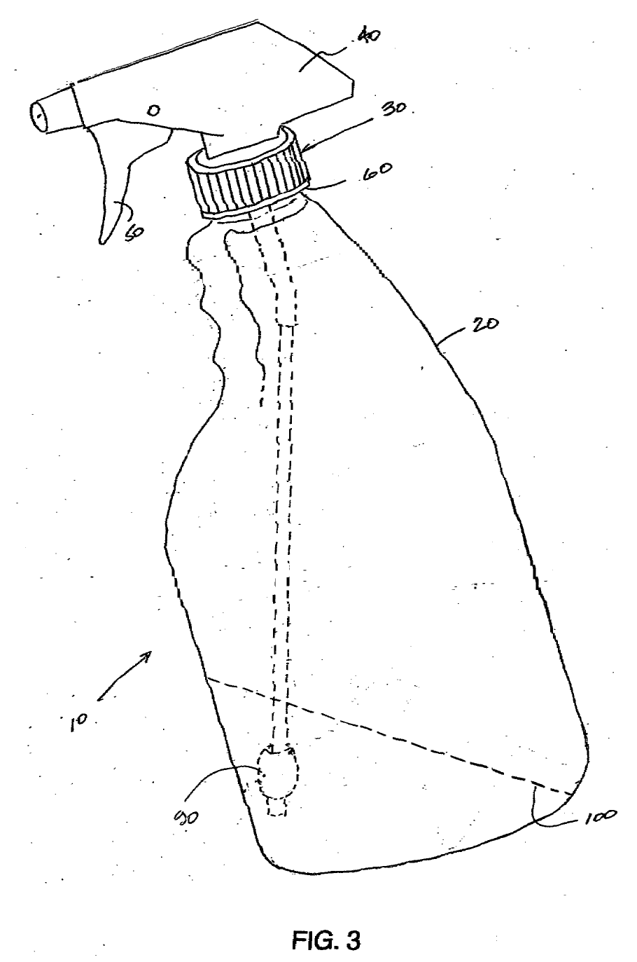

FIG. 3 demonstrates this “following” action of tube 70 as the bottle is positioned more horizontally.

Not shown is the preferred embodiment of applicant's invention using a source tube 70′ which is extremely flexible along its entire length, but still provided with a weight 90′. In this embodiment, it is unnecessary to provide the flexible sleeve 80 depicted in FIG. 2, because of the inherent flexibility of the entire source tube 70′ which would typically be substantially longer than the preferred embodiment shown in FIGS. 1 through 3. Said longer source tube may be employed to assure that only the tiniest fraction of product remains unused as product levels approach zero, and that the end of the source tube may be located in the farthest reaches of the spray bottle. With such a source tube, there is no need for such a flexible sleeve as in the preferred embodiment.

It is anticipated that applicant's invention will be used primarily with plastic or glass spray bottles where the spray nozzles, source tubes and sleeves are made from inexpensive, economical and disposable materials commonly used for consumer products such as cleaning agents agents or perfumes, etc. In the case of more commercial applications, more longlasting materials such as the clamp and swivel or metallic and hard plastics may be used for the source tube, weight, flexible sleeve etc. The materials used would be consistent with those used in the art of such spray bottles.

While the invention has been described in connection with what is presently considered the most practical and preferred embodiment(s), it is to be understood that the invention is not limited to the disclosed embodiment(s) but, on the contrary is intended to cover various modifications and equivalent arrangements included within the scope of the appended claims.

What is claimed is:

1. An improved spray bottle comprising:
a vessel having a threaded mouth;
a delivery mechanism further comprising a spray nozzle, said nozzle actuated by a trigger, said nozzle joined with a threaded cap sized to be screwed upon and mated with said vessel's mouth;
a source tube having proximate to one end a flexible sleeve and at the other end a weight, said source tube in communication with said nozzle, said tube sized to extend proximate to the furthest interior of said vessel such that when said trigger is squeezed, any liquid in said vessel is drawn through said tube for delivery out said nozzle.

2. An improved spray bottle comprising:
a vessel having a threaded mouth;
a delivery mechanism further comprising a spray nozzle, said nozzle actuated by a trigger, said nozzle joined with a threaded cap sized to be screwed upon and mated with said vessel's mouth;
a source tube of highly flexible material having proximate to one end a weight, said source tube in communication with said nozzle at its other end, said tube sized to extend at least proximate to the furthest interior of said vessel such that when said trigger is squeezed, any liquid in said vessel is drawn through said tube for delivery out said nozzle.

3. An improved spray bottle comprising:
a vessel having a threaded mouth;
a delivery mechanism further comprising a spray nozzle, said nozzle actuated by a trigger, said nozzle joined with a threaded cap sized to be screwed upon and mated with said vessel's mouth;
a source tube at one end in communication with said nozzle by a flexible junction and at the other end a weight, said tube sized to extend proximate to the furthest interior of said vessel such that when said trigger is squeezed, said weight locates said source tube proximate to the bottom portion of any liquid in said vessel, said liquid then being drawn through said tube for delivery out said nozzle.

4. The device of claim 3 wherein:
said junction comprising a clamp and swivel.

5. The device of claim 3 wherein:
said junction comprising a flexible sleeve.
